(19) United States
(12) Patent Application Publication
(10) Pub. No.: US 2020/0055171 A1
(43) Pub. Date: Feb. 20, 2020

(54) Nuffle

(71) Applicant: Cheston O'neal Dooley, Raleigh, NC (US)

(72) Inventor: Cheston O'neal Dooley, Raleigh, NC (US)

(21) Appl. No.: 16/105,548

(22) Filed: Aug. 20, 2018

(51) Int. Cl. B25B 27/00; B25B 13/48; B67C 11/00

(52) U.S. Cl. CPC B25B 27/0042; B67C 11/00; B25B 13/48

(57) ABSTRACT

Hand Tool that combines a funnel and a socket-wrench extension into one device. The Nuffle makes engine oil changes easier by integrating both the device used to remove oil-pan drain plugs and the device used to direct the flow of fluids draining from the engine. The Nuffle eliminates the numerous hazards of using a separate funnel and socket-wrench to perform engine oil changes in both home and commercial settings.

My invention is called a “Nuffle”. The Nuffle was conceived with the intent of making automobile maintenance easier; specifically it would be used to assist in the process of “changing the oil” in automobiles and other machines with engines that use motor oil. The Nuffle would serve a dual function; it would serve as a way to remove oil-pan drain plugs (similar to existing socket-wrenches) and also serve as a funnel to drain the oil. The Nuffle brings two existing devices together as one, thus making automobile maintenance easier and safer.

The Nuffle is part funnel and part socket-wrench extension. The Nuffle combines the funnel and the socket wrench extension into a device that is both a tool and a socket-wrench extension. The Nuffle solves the problem of losing or misplacing the oil-pan drain plug during an engine oil change, by eliminating the need to quickly remove the oil-pan drain plug and place a funnel underneath the oil-pan drain hole. The Nuffle can do this because the tool you use you remove the oil-pan drain plug is the same tool you would use as a funnel to direct the flow of the draining engine oil to your desired location.

The Nuffle was conceived with the intent of being compatible with existing socket wrenches. It would be as easy to use as a typical extension piece, and would also function as such. The “funnel-side” of the Nuffle would have a “socket-male” component that would accommodate existing sockets. The opposite side of the Nuffle would have a “socket-female” component that would accommodate existing socket wrenches. The Nuffle would also be made from the same alloys as existing socket wrenches to it could match that standard of durability and visual appeal.

The Nuffle is a unique device in multiple aspects; not only does the Nuffle combine the funnel and the socket-wrench extension, it also integrates them. It does this by making the shaft component of the tool hollow, so engine oil can drain through it and out of it. The funnel component of the device would serve to direct the flow of fluid as well as to capture the oil-pan drain plug should it fall out of the socket used to remove it (located at the center of the funnel component).

The enclosed conceptual drawings demonstrate how the Nuffle looks and operates.

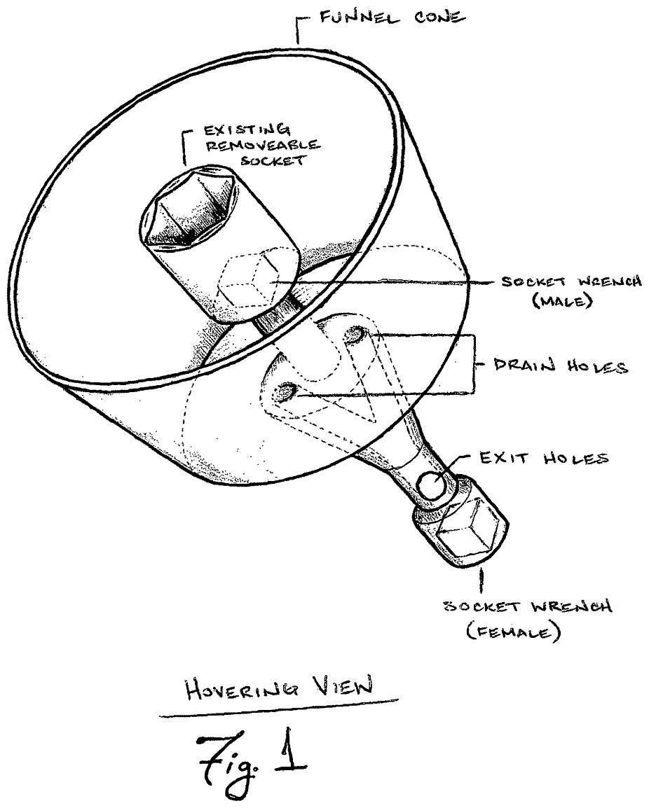

FIG. 1 is a hovering bird's eye view of the Nuffle device. This drawing shows the 2 main components of the device (funnel & shaft). This figure should be used at the primary image in publication.

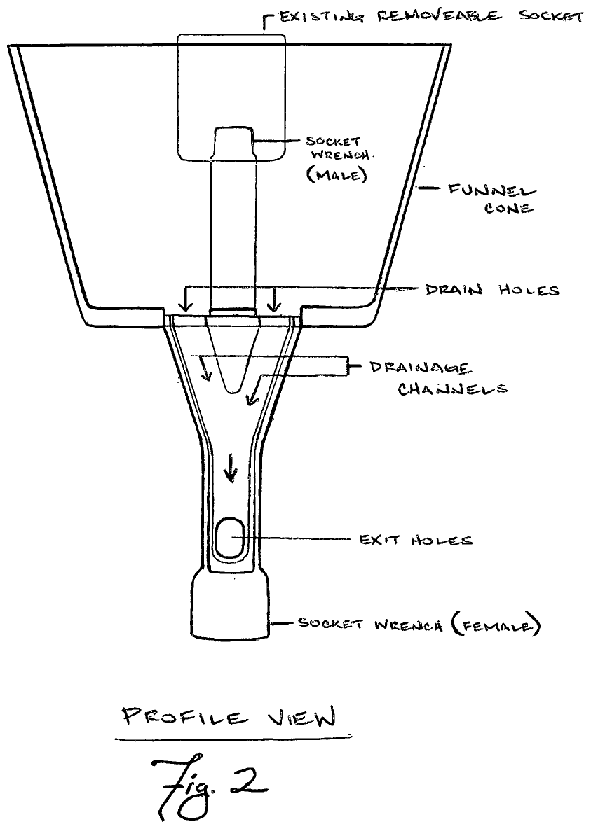

FIG. 2 is a profile view of the Nuffle device

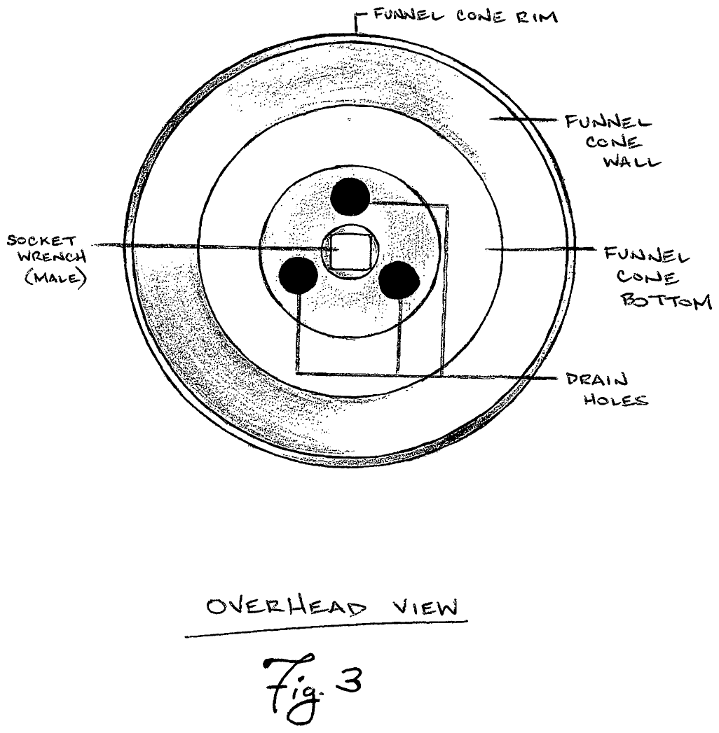

FIG. 3 is an overhead view

1. Metallic funnel device combined with a metallic hand tool device—when combined, can act as a funnel and remove fasteners (bolts)

2. Hollow metallic socket wrench extension accessory used to channel draining fluids (as the shaft portion of a funnel)

3. Metallic funnel device as a socket wrench accessory

4. Metallic socket wrench accessory used to remove and capture fasteners in a “funnel like” device
